(19) United States
(12) Patent Application Publication
(10) Pub. No.: US 2025/0031677 A1
(43) Pub. Date: Jan. 30, 2025

(54) FISH TANK CLEANING WATER PUMP

(71) Applicant: BAIPING GUI, Yongzhou (CN)

(72) Inventor: HAITAO GUI, Dongguan (CN)

(21) Appl. No.: 18/750,390

(22) Filed: Jun. 21, 2024

(30) Foreign Application Priority Data
Jul. 27, 2023 (CN) 202321998401.1

(51) Int. Cl. A01K 63/04

(52) U.S. Cl. CPC A01K 63/047; A01K 63/045

(57) ABSTRACT

A fish tank cleaning water pump is provided, which includes a housing having a shape of convex cover. A top of an inner wall of the housing is provided with a power cord outlet, a bottom of the housing is provided with a double-layer hood-shaped base. A top of the double-layer hood-shaped base is provided with a water pump upper component, a top of the water pump upper component is fixedly connected to the top of the inner wall of the housing. The beneficial effect of the present disclosure is that a cleaning chamber is provided, and a return water channel is provided at an isolation position between a top of the cleaning chamber and a top of the housing. A peripheral border of a side wall of the housing and an outer border of the double-layer hood-shaped base form a sealed water injection pressure chamber.

### CROSS-REFERENCE TO RELATED APPLICATIONS

This application claims priority to Chinese Patent Application No. 202321998401.1, filed on Jul. 27, 2023, which is hereby incorporated by reference in its entirety.

### TECHNICAL FIELD

The present disclosure relates to the field of fish tank cleaning technologies, and in particular, to a new type of double-layer pressurized and multi-stage cleaning fish tank cleaning water pump.

### BACKGROUND

With a further development of society and an improvement of people's living standards, fish has entered the public's vision. However, large quantities of excrement and fish feed residues produced by fish will accumulate in a fish tank. If not cleaned up, the excrement and fish feed residues produced by fish will quickly deteriorate water quality, not only causing unpleasant taste, but also causing fish death, and resulting in greater damage to mental and property of fish owner. Therefore, it is necessary to regularly clean them up.

During a cleaning process of the fish tank, it is necessary to extract water from the tank and replace it with new water to maintain hygiene of the water, and a water pump is usually used to complete a pumping operation.

However, in existing technologies, a workload of replacing all water by the existing fish tank water pump is indeed relatively large. Due to a need to replace all water in the fish tank, and a difficulty in completely removing fish discharge and fish feed residue under bottom stones during water replacement, single stage filter screens are often used after three cleaning in existing technologies. Large debris can block and damage the operation of a water pump blade rotor. Water with impurities that does not pass through a clean screen will pass through a return water channel, and it is prone to clogging a water injection port of an injection pressure water chamber. All small and large debris flows to a final fine filter screen sleeve, which is prone to stacking debris in the fine filter sleeve due to too much debris, and thereby forming blockage, and it is not conducive to a practical application.

### SUMMARY

In response to the aforementioned issues in existing technology, a purpose of the present disclosure is to provide an integrated fish tank cleaning water pump, and to provide specific solutions to problems faced by leisure fish farming.

The technical solution of the present disclosure is as follows: a fish tank cleaning water pump, including a housing, where the housing has a shape of convex cover, a top of an inner wall of the housing is provided with a power cord outlet, a bottom of the housing is provided with a double-layer hood-shaped base, and a top of the double-layer hood-shaped base is provided with a water pump upper component; a top of the water pump upper component is fixedly connected to the top of the inner wall of the housing, an outer side of the double-layer hood-shaped base is fixedly connected to an outer border; a side wall of the housing with the double-layer hood-shaped base and the outer border form a sealed water injection pressure chamber; the top of the inner wall of the housing is fixedly connected to a cleaning chamber, a return water channel is provided at an isolation position between the cleaning chamber and a top of the housing; and a pressure regulating valve is provided at a water outlet position of the cleaning chamber and above the housing; the water injection pressure chamber is communicated with an interior of the return water channel.

In an embodiment of the present disclosure, the top of the double-layer hood-shaped base is fixedly connected to a water pump base, the water pump base is configured to fix the water pump, a top of an inner wall of the double-layer hood-shaped base is provided with a water pump inlet, a top of the water pump base is provided with a water pump outlet guide groove, and the inner wall of the double-layer hood-shaped base is provided with a plurality of water outlets that are communicated with an interior of the water injection pressure chamber; a bottom of the double-layer hood-shaped base is provided with a plurality of inlet recessed holes.

In an embodiment of the present disclosure, the water pump upper component includes a water pump upper housing, the water pump upper housing is fixedly connected between the top of the inner wall of the housing and the top of the water pump base, and the water pump upper housing is internally provided with a sealant sealed water pump coil, which is a water pump coil structure filled with sealant; a center of the sealant sealed water pump coil is provided with an isolation space and a water pump blade rotor; the top of the inner wall of the double-layer hood-shaped base is fixedly connected to a water blocking edge; a bottom of the cleaning chamber that is located in an interior of the water pump outlet guide groove is fixedly connected to a water outlet pipe, and a top of the water outlet pipe extends to an interior of the cleaning chamber.

In an embodiment of the present disclosure, a water flow generated by a rotation of the water pump blade rotor is greater than a total flow of the pressure regulating valve and the water outlets.

In an embodiment of the present disclosure, the bottom of the cleaning chamber is fixedly connected with a cleaning chamber inlet bushing, the cleaning chamber inlet bushing is sleeved on an outer side of the water outlet pipe, and a detachable cleaning net is provided in the cleaning chamber and above the water outlet pipe; a top of the cleaning chamber is provided with a detachable cleaning chamber top cover, and a top of the cleaning chamber top cover is fixedly connected with a cleaning chamber drainage pipe; the pressure regulating valve is fixedly connected to a top of the cleaning chamber drainage pipe; a return water through-hole configured to supply water for the water injection pressure chamber is provided at an insolation position between the top of the cleaning chamber and the top of the housing; the outer side of the double-layer hood-shaped base is provided with a plurality of return water outlets.

In an embodiment of the present disclosure, the top of the cleaning chamber top cover is fixedly connected to a fine substance filter sleeve; one side of the pressure regulating valve away from the cleaning chamber drainage pipe is located in the fine substance filter sleeve.

In an embodiment of the present disclosure, one side of the pressure regulating valve away from the cleaning chamber drainage pipe is fixedly connected to an external outlet water hose.

In an embodiment of the present disclosure, the top of the housing is fixedly connected to a wire conduit fixing base, a top of the wire conduit fixing base is fixedly connected to a bushing fastening component, and one side of the bushing fastening component away from the wire conduit fixing base is provided with a wire bushing; the wire bushing is adjusted through the bushing fastening component, and one end of the wire bushing away from the bushing fastening component is fixedly connected to a handle.

In an embodiment of the present disclosure, a waterproof rubber gasket is provided between the wire conduit fixing base and a top of the sealant sealed water pump coil, and a power cord sequentially passes through the top of the sealant sealed water pump coil, the power cord outlet, the wire conduit fixing base, and the wire bushing, extends to one side of the handle and is electrically connected to an external control device.

In an embodiment of the present disclosure, the top of the inner wall of the double-layer hood-shaped base is fixedly connected to a water pump inlet filter grid.

Compared with existing technologies, the advantages and positive effects of the present disclosure are:
in the present disclosure, a cleaning chamber is provided, and a return water channel is provided at the isolation position between the top of the cleaning chamber and the top of the housing. The peripheral border of the side wall of the housing and the outer border of the double-layer hood-shaped base form a sealed water injection pressure chamber. The water pump base at the top of the double-layer hood-shaped base and the lower of the water pump upper component form a sealed water pumping-and-pressurization system, thereby providing a sufficient pressure water flow for the cleaning chamber and the water injection pressure chamber, generating partial reflux to flush the stones at the bottom of the fish tank, and extracting impurities from the stone gaps. At the same time, water pressure is generated to discharge some of the stones after subsequent double filtration, thereby achieving a multi-stage purification cycle of water in the fish tank. The purification and impurity removal of the water body can be completed without the need for complete water replacement. When whole water replacement is needed, by connecting the outlet end of the pressure regulating valve to the external water outlet hose, water in the fish tank can be completely drained and replaced.

### BRIEF DESCRIPTION OF DRAWINGS

FIG. 1 is a schematic diagram of an overall structure of a fish tank cleaning water pump provided by the present disclosure.

FIG. 2 is a schematic diagram of a local structure of the fish tank cleaning water pump in a section view provided by the present disclosure.

FIG. 3 is a schematic diagram of an external structure of a double-layer hood-shaped base of the fish tank cleaning water pump provided by the present disclosure.

FIG. 4 is a schematic diagram of an installation surface structure of a water pump upper component of the fish tank cleaning water pump provided by the present disclosure.

FIG. 5 is a schematic diagram of an internal structure of the double-layer hood-shaped base of the fish tank cleaning water pump provided by the present disclosure.

FIG. 6 is a schematic structural diagram of a fastening component of the fish tank cleaning water pump provide by the present disclosure.

FIG. 7 is a schematic diagram of an overall structure of the fish tank cleaning water pump with an external water outlet hose provided by the present disclosure.

Numeral reference, 1—housing; 101—power cord outlet; 102—waterproof rubber gasket; 103—wire conduit fixing base; 104—water injection pressure chamber; 2—water pump upper component; 201—sealant sealed water pump coil; 202—power cord; 203—water pump blade rotor; 204—water outlet pipe; 205—water pump upper housing; 206—water blocking edge; 3—double-layer hood-shaped base; 301—water pump base; 302—water pump inlet; 303—water pump outlet guide groove; 304—water outlet; 305—inlet recessed hole; 306—outer border; 4—cleaning chamber; 401—cleaning chamber inlet bushing; 402—detachable cleaning net; 403—return water outlet; 404—cleaning chamber top cover; 405—cleaning chamber drainage pipe; 5—pressure regulating valve; 6—fine substance filter sleeve; 7—external outlet water hose; 8—wire bushing; 9—bushing fastening component; 10—water pump inlet filter grid; 11—handle.

### DESCRIPTION OF EMBODIMENTS

In order to clarify the purpose, technical solution, and advantages of the embodiments of the present disclosure, the following will provide a clear and complete description of the technical solution in the embodiments of the present disclosure in combination with the accompanying drawings. Obviously, the described embodiments are a part of the embodiments of the present disclosure, not all of them. The components of the embodiments of the present disclosure, which are typically described and shown in the accompanying drawings, can be arranged and designed in various different configurations. Therefore, the following detailed description of the embodiments of the present disclosure provided in the drawings is not intended to limit the protection scope of the present disclosure, but only to represent the selected embodiments of the present disclosure. Based on the embodiments in the present disclosure, all other embodiments obtained by those skilled in the art without creative work fall within the protection scope of the present disclosure.

The following will refer to the attached drawings and specific embodiments to further explain the present disclosure.

### Embodiment 1

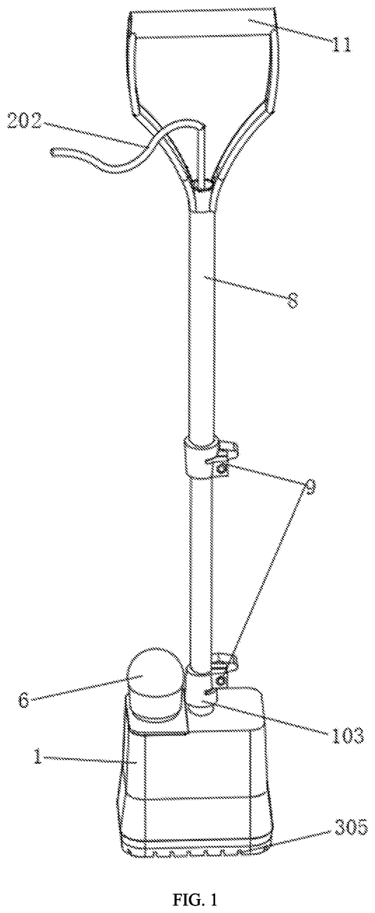

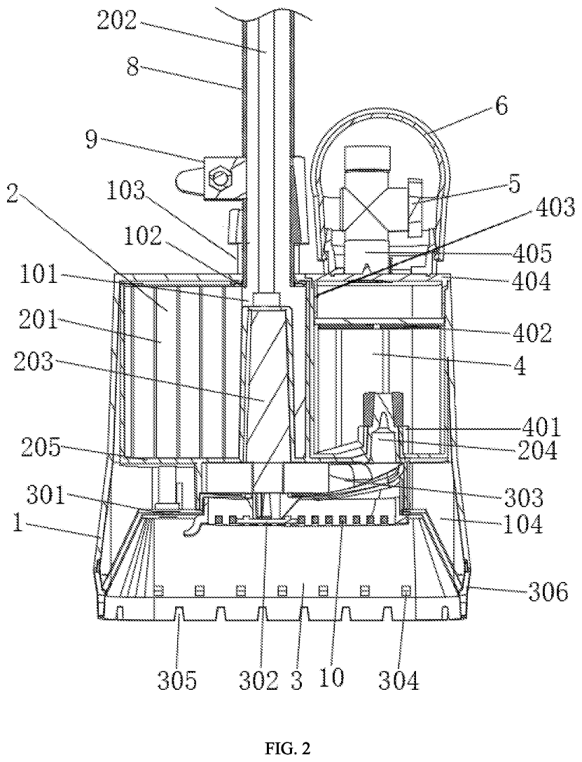

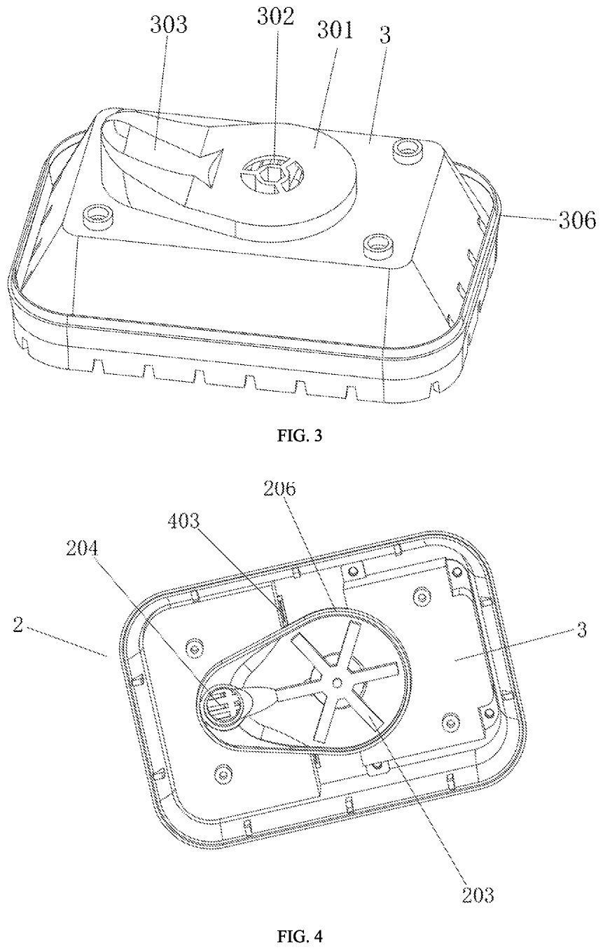

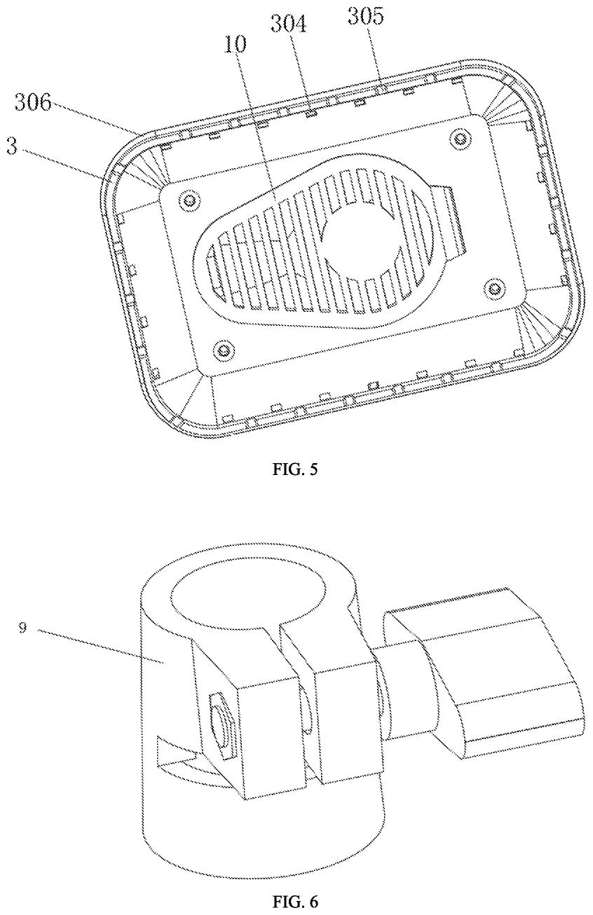

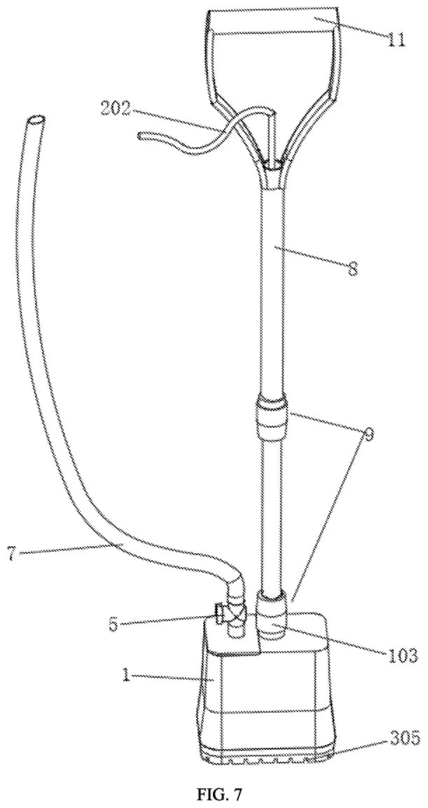

As shown in FIGS. 1-6, the present disclosure provides a novel double-layer pressurized and multi-stage cleaning fish tank cleaning water pump, including a housing 1. The housing 1 has a convex cover shape, a top of an inner wall of the housing 1 is provided with a power cord outlet 101. A bottom of the housing 1 is provided with a double-layer hood-shaped base 3. A top of the double-layer hood-shaped base 3 is provided with a water pump upper component 2, and a top of the water pump upper component 2 is fixedly connected to the top of the inner wall of the housing 1. An outer side of the double-layer hood-shaped base 3 is fixedly connected to an outer border 306. One side wall of the housing 1 forms a sealed water injection pressure chamber 104 with the double-layer hood-shaped base 3 and the outer border 306. The top of the inner wall of the housing 1 is fixedly connected to the cleaning chamber 4. A return water channel is provided at an isolation position between the cleaning chamber 4 and the top of the housing 1. A pressure regulating valve 5 is provide at a water outlet position of the cleaning chamber 4 and above the housing 1. The water injection pressure chamber 104 is connected to an interior of the return water channel. As the pressure of the water injection pressure chamber 104 increases, water from the water injection pressure chamber 104 passes through the water outlet 304 and rushes downwards from a periphery of the double-layer hood-shaped base 3 to flush all objects below the double-layer hood-shaped base 3. The water outlet 304 shoots out at an angle towards a bottom of the double-layer hood-shaped base 3. The water flow with a flushing force rolls and washes sand particles and small stones in the double-layer hood-shaped base 3, and also blows up excrement and fish feed residue hidden at the bottom, thereby forming a continuous rolling scene in the double-layer hood-shaped base 3, which is convenient to clean up impurities in gaps of the stones.

In this embodiment, the top of the double-layer hood-shaped base 3 is fixedly connected to a water pump base 301, which is configured to fix the water pump. The top of the inner wall of the double-layer hood-shaped base 3 is provided with a water pump inlet 302, and a top of the water pump base 301 is provided with a water pump outlet guide groove 303. The inner wall of the double-layer hood-shaped base 3 is provided with a plurality of water outlets 304 that are communicated with an interior of the water injection pressure chamber 104. The bottom of the double-layer hood-shaped base 3 is provided with a plurality of inlet recessed holes 305. Due to a cross design of the water outlet 304 and the inlet recessed hole 305, both of which are located at the bottom of the double-layer hood-shaped base 3, which renders the bottom periphery of the double-layer hood-shaped base 3 have a denser water flow, the denser water flow is converged together to flush the excrement and fish feed residue towards a center position of the bottom of the double-layer hood-shaped base 3, and the water pump inlet 302 located at a center position of the top of the double-layer hood-shaped base 3 intercepts larger objects and more sewage is promptly sucked in by a water pump inlet filter grid 10, and thereby quickly diluting sewage impurities in the double-layer hood-shaped base 3.

In this embodiment, the water pump upper component 2 includes a water pump upper housing 205, which is fixedly connected between the top of the inner wall of the housing 1 and the top of the water pump base 301. The water pump upper housing 205 is internally provided with a sealant sealed water pump coil 201, and the sealant sealed water pump coil 201 is a water pump coil structure filled with sealant. A center of the sealant sealed water pump coil 201 is provided with an isolation space and a water pump blade rotor 203. The top of the inner wall of the double-layer hood-shaped base 3 is fixedly connected to a water blocking edge 206. A bottom of the cleaning chamber 4 that is located at an interior of the water pump outlet guide groove 303 is fixedly connected to a water outlet pipe 204, a top of the water outlet pipe 204 extends to an interior of the cleaning chamber 4. The water pump upper component 2 and the water pump base 301 at the top of inner layer of the double-layer hood-shaped base 3 form a sealed water pumping-and-pressurization system. Water enters from the water pump inlet 302, after being pressurized by the water pump, flows from the water outlet pipe 204 to the cleaning chamber 4. A periphery of the bottom of the housing 1, the double-layer hood-shaped base 3, the outer border 306, and the cleaning chamber 4 form a sealed water injection pressure chamber 104. The water that is pressurized by the water pump flows from the water outlet pipe 204 to the cleaning chamber 4.

In this embodiment, a flow rate generated by a rotation of the water pump blade rotor 203 is greater than a total flow rate of the pressure regulating valve 5 and the water outlet 304, so that the injection pressure chamber 104 has a sufficient pressure to eject the water from the pressure chamber.

In this embodiment, the bottom of the cleaning chamber 4 is fixedly connected with a cleaning chamber inlet bushing 401, which is sleeved at an outer side of the water outlet pipe 204. A detachable cleaning net 402 is provided in the cleaning chamber 4 and above the water outlet pipe 204. A top of the cleaning chamber 4 is provided with a detachable cleaning chamber top cover 404. A top of the cleaning chamber top cover 404 is fixedly connected with a cleaning chamber drainage pipe 405. A pressure regulating valve 5 is fixedly connected to a top of the cleaning chamber drainage pipe 405, and a return water through-hole configured to supply water to the water injection pressure chamber 104 is provided at an isolation position between the top of the cleaning chamber 4 and the top of the housing 1. A plurality of return water outlets 403 are provided on an outer side of the double-layer hood-shaped base 3, water enters from the water pump inlet 302, is pressurized by the water pump, and reaches to the cleaning chamber 4 through the water outlet pipe 204. After being filtered by the detachable cleaning net 402, a part of clean water flows back from the water return channel to the water injection pressure chamber 104 and is ejected through the water outlet 304, and impurities are then deposited in the cleaning chamber 4 by gravity.

In this embodiment, the top of the cleaning chamber top cover 404 is fixedly connected to a fine substance filter sleeve 6. One end of the pressure regulating valve 5, which is far away from the cleaning chamber drainage pipe 405, is located in the fine substance filter sleeve 6. A part of clean water flows through the pressure regulating valve 5 of the cleaning chamber drainage pipe 405 to the fine substance filter sleeve 6, and after cleaning, it flows into the fish tank or is discharged outside the fish tank through an external outlet water hose 7.

In this embodiment, the top of the housing 1 is fixedly connected to a wire conduit fixing base 103, and a top of the wire conduit fixing base 103 is fixedly connected to a bushing fastening component 9. One side of the bushing fastening component 9 away from the wire conduit fixing base 103 is provided with a wire bushing 8, which is adjusted through the bushing fastening component 9. One end of the wire bushing 8 away from the bushing fastening component 9 is fixedly connected to a handle, which is convenient to adjust a distance between the handle and the housing 1, and it is convenient to use and adapt to different operators.

In this embodiment, a waterproof rubber gasket 102 is provided between the wire conduit fixing base 103 and a top of the sealant sealed water pump coil 201, which facilitates a passage of the power cord 202 so as to prevent water leakage in the pressure chamber. A power cord 202 sequentially passes through the top of the sealant sealed water pump coil 201, the power cord outlet 101, the wire conduit fixing base 103, and the wire bushing 8, extends to one end of the handle, and is electrically connected to an external control device, thereby providing a drive for the water pump blade rotor 203.

The top of the inner wall of the double-layer hood-shaped base 3 is fixedly connected to a water pump inlet filter grid 10, which is configured to intercept large objects from entering the water pump blade rotor 203.

Where, there are three levels filtering.

First level filtering: the water pump inlet filter grid, which blocks large hard objects with a diameter of more than 3 mm (preventing damage to the water pump blade rotor).

Second level filtering: cleaning net, there are a plurality of types of cleaning nets. Replacing cleaning nets with different specifications can achieve filtering of material with different sizes. Water before the return water channel can be cleaned so as to prevent debris from blocking the water outlet of the water injection pressure chamber.

Third level filtering: fine substance filter sleeve: which cleans the water from the cleaning chamber again to meet higher standards of cleaning requirements.

### Embodiment 2

As shown in FIG. 7, one side of the pressure regulating valve 5 away from the cleaning chamber drainage pipe 405 is fixedly connected to an external outlet water hose 7. The pressure regulating valve 5 can be connected to the external outlet water hose 7 to achieve extraction and discharge of water in the fish tank, or the external outlet water hose 7 can be directly inserted into the water outlet pipe 204 to perform water extraction and exchange work, maximizing the water flow rate without using the cleaning chamber 4, detachable cleaning net 402, water injection pressure chamber 104, pressure regulating valve 5, and fine substance filter sleeve 6.

### Working Principle:

As shown in FIGS. 1-7, the water pump upper component 2 is installed on the top of the interior of the housing 1. The water pump upper component 2 and the water pump base 301 at the top of the inner layer of the double-layer hood-shaped base 3 form a sealed water pumping-and-pressurization system. The water enters from the water pump inlet 302, and after being pressurized by the water pump, it flows from the water outlet pipe 204 to the cleaning chamber 4. The periphery of the bottom of the housing 1, the double-layer hood-shaped base 3, the outer border 306, and the cleaning chamber 4 form a sealed water injection pressure chamber 104. The water that is pressurized by the water pump enters the cleaning chamber 4 from the water outlet pipe 204. As the water outlet pipe 204 in the cleaning chamber 4 is upward and has a fixed height, the water outlet pipe 204 is upward, and the cleaning net is also located above. The cleaning chamber drainage pipe 405 and the return water channel are also located above. Using the principle of gravity, a large and heavy substance is allowed to fall to the bottom of the cleaning chamber 4, a collection of impurities is completed, (it is also possible to directly insert the external outlet water hose 7 into the water outlet pipe 204 to pump and change water, maximizing the water flow without using the cleaning chamber 4, detachable cleaning net 402, water injection pressure chamber 104, pressure regulating valve 5, and fine substance filter sleeve 6). After sewage is cleaned by the cleaning net, a part of clean water flows through the pressure regulating valve 5 of the cleaning chamber drainage pipe 405 to the fine substance filter sleeve 6. After cleaning, it flows into the fish tank, or is discharged outside the fish tank through the external outlet water hose 7. The fish tank has its own filtering equipment for re-cleaning, and a part of clean water flows from the return water channel to the water outlet 304 of the water injection pressure chamber 104 and is ejected out. As the pressure in the water injection pressure chamber 104 increases, the water in the water injection pressure chamber 104 passes through the water outlet 304 and rushes downwards from the periphery of the double-layer hood-shaped base 3 to flush all objects below the double-layer hood-shaped base 3. The water outlet 304 shoots out at an angle towards the double-layer hood-shaped base 3, and the water flow with a flushing force rolls and washes the sand particles and small stones in the double-layer hood-shaped base 3, while also blowing up the hidden excrement and fish feed residue at the bottom, thus, forming a continuous rolling scene in the double-layer hood-shaped base 3 (but does not affect the water quality outside the double-layer hood-shaped base 3); the other part of clean water flows through a cleaning water outlet, reaches the pressure regulating valve 5, and flows out, or is directedly flowed to the outside of the fish tank through an external outlet water hose 7. The water volume in the double-layer hood-shaped base 3 will decrease. At this time, the inlet recessed hole 305 at an edge of the double-layer hood-shaped base 3 will timely suck in new water. Due to a cross design of the water outlet 304 and the inlet recessed hole 305, both are located at the bottom of the double-layer hood-shaped base 3, which renders the bottom peripheral of the double-layer hood-shaped base 3 have a denser water flow. The denser water follow is converged together to flush the excrement and fish feed residue towards the center position of the bottom of the double-layer hood-shaped base 3. The water pump inlet 302 located at the center position of the top of the double-layer hood-shaped base 3 will intercept larger objects and timely suck in more sewage through the water pump inlet filter grid 10, thereby quickly diluting the sewage impurities in the double-layer hood-shaped base 3. The sewage impurities in the double-layer hood-shaped base 3 are filtered through the water pump inlet filter grid 10 again, and enter from the water pump inlet 302. After being pressurized by the water pump, reach to the cleaning chamber 4 through the water outlet pipe 204. After being cleaned by the detachable cleaning net 402, a part of clean water flows back from the water return channel to the water injection pressure chamber 104 and is ejected out through the water outlet 304. A part of clean water flows through the pressure regulating valve 5 of the cleaning chamber drainage pipe 405 to the fine substance filter sleeve 6. After cleaning, it flows into the fish tank or is discharged outside the fish tank through an external outlet water hose 7. The above processes are quickly circulated to achieve a rapid cleaning of sand particles, fish excrement, and fish feed residues hidden at the bottom of the fish tank. The power cord 202 passed through the through-hole of the wire conduit fixing base 103 at the top of the housing 1, and a waterproof rubber gasket 102 is provided to prevent water leakage in the water injection pressure chamber 104 which results in insufficient pressure. The wire conduit fixing base 103 is tightly fastened to one side of the bushing fastening component 9, while the other side is provided with a wire bushing 8 with adjustable elasticity. And other bushing fastening component 9 is connected to the handle 11, and the power cord 202 is led out from one end of the handle 11 through the wire bushing 8.

Finally, it should be noted that the above embodiments are only used to illustrate the technical solution of the present disclosure, and not to limit it; although detailed explanations have been provided for the present disclosure with reference to the aforementioned embodiments, those skilled in the art should understand that it is still possible to modify the technical solution recorded in the aforementioned embodiments, or to equivalently substitute some or all of the technical features therein; these modifications or substitutions do not render the essence of the corresponding technical solutions deviate from the scope of the technical solutions of each embodiment of the present disclosure.

What is claimed is:

1. A fish tank cleaning water pump, comprising a housing, wherein the housing has a shape of convex cover, a top of an inner wall of the housing is provided with a power cord outlet, a bottom of the housing is provided with a double-layer hood-shaped base, and a top of the double-layer hood-shaped base is provided with a water pump upper component; a top of the water pump upper component is fixedly connected to the top of the inner wall of the housing, an outer side of the double-layer hood-shaped base is fixedly connected to an outer border; a side wall of the housing with the double-layer hood-shaped base and the outer border form a sealed water injection pressure chamber; the top of the inner wall of the housing is fixedly connected to a cleaning chamber, a return water channel is provided at an isolation position between the cleaning chamber and a top of the housing; and a pressure regulating valve is provided at a water outlet position of the cleaning chamber and above the housing; the water injection pressure chamber is communicated with an interior of the return water channel.

2. The fish tank cleaning water pump according to claim 1, wherein the top of the double-layer hood-shaped base is fixedly connected to a water pump base, the water pump base is configured to fix the water pump, a top of an inner wall of the double-layer hood-shaped base is provided with a water pump inlet, a top of the water pump base is provided with a water pump outlet guide groove, and the inner wall of the double-layer hood-shaped base is provided with a plurality of water outlets that are communicated with an interior of the water injection pressure chamber; a bottom of the double-layer hood-shaped base is provided with a plurality of inlet recessed holes.

3. The fish tank cleaning water pump according to claim 2, wherein the water pump upper component comprises a water pump upper housing, the water pump upper housing is fixedly connected between the top of the inner wall of the housing and the top of the water pump base, and the water pump upper housing is internally provided with a sealant sealed water pump coil, which is a water pump coil structure filled with sealant; a center of the sealant sealed water pump coil is provided with an isolation space and a water pump blade rotor; the top of the inner wall of the double-layer hood-shaped base is fixedly connected to a water blocking edge; a bottom of the cleaning chamber that is located in an interior of the water pump outlet guide groove is fixedly connected to a water outlet pipe, and a top of the water outlet pipe extends to an interior of the cleaning chamber.

4. The fish tank cleaning water pump according to claim 3, wherein a water flow generated by a rotation of the water pump blade rotor is greater than a total flow of the pressure regulating valve and the water outlets.

5. The fish tank cleaning water pump according to claim 3, wherein the bottom of the cleaning chamber is fixedly connected with a cleaning chamber inlet bushing, the cleaning chamber inlet bushing is sleeved on an outer side of the water outlet pipe, and a detachable cleaning net is provided in the cleaning chamber and above the water outlet pipe; a top of the cleaning chamber is provided with a detachable cleaning chamber top cover, and a top of the cleaning chamber top cover is fixedly connected with a cleaning chamber drainage pipe; the pressure regulating valve is fixedly connected to a top of the cleaning chamber drainage pipe; a return water through-hole configured to supply water for the water injection pressure chamber is provided at an insolation position between the top of the cleaning chamber and the top of the housing; the outer side of the double-layer hood-shaped base is provided with a plurality of return water outlets.

6. The fish tank cleaning water pump according to claim 5, wherein the top of the cleaning chamber top cover is fixedly connected to a fine substance filter sleeve; one side of the pressure regulating valve away from the cleaning chamber drainage pipe is located in the fine substance filter sleeve.

7. The fish tank cleaning water pump according to claim 1, wherein one side of the pressure regulating valve away from the cleaning chamber drainage pipe is fixedly connected to an external outlet water hose.

8. The fish tank cleaning water pump according to claim 3, wherein the top of the housing is fixedly connected to a wire conduit fixing base, a top of the wire conduit fixing base is fixedly connected to a bushing fastening component, and one side of the bushing fastening component away from the wire conduit fixing base is provided with a wire bushing; the wire bushing is adjusted through the bushing fastening component, and one end of the wire bushing away from the bushing fastening component is fixedly connected to a handle.

9. The fish tank cleaning water pump according to claim 8, wherein a waterproof rubber gasket is provided between the wire conduit fixing base and a top of the sealant sealed water pump coil, and a power cord sequentially passes through the top of the sealant sealed water pump coil, the power cord outlet, the wire conduit fixing base, and the wire bushing, extends to one side of the handle and is electrically connected to an external control device.

10. The fish tank cleaning water pump according to claim 3, wherein the top of the inner wall of the double-layer hood-shaped base is fixedly connected to a water pump inlet filter grid.
